(19) United States
(12) Patent Application Publication
(10) Pub. No.: US 2007/0088704 A1
(43) Pub. Date: Apr. 19, 2007

(54) System and method for creation, distribution, and utilization of portable knowledge format

(76) Inventors: Julian Bourne, Toronto (CA); Dennis Wu, Toronto (CA); Jeff Bonnell, Burlington (CA); Eric Kar, Toronto (CA); David Gray, Sharon (CA); Kevin Moon, North York (CA)

Correspondence Address: THELEN REID BROWN RAYSMAN & STEINER LLP, 900 THIRD AVENUE, NEW YORK, NY, 10022, US

(21) Appl. No.: 11/332,778

(22) Filed: Jan. 13, 2006

Related U.S. Application Data
(60) Provisional application No. 60/728,041, filed on Oct. 17, 2005.

(51) Int. Cl. G06F 17/30

(52) U.S. Cl. 707/10

(57) ABSTRACT

The present invention relates to systems and methods for facilitating the distribution of content in an accessible data structure. The method of the present invention comprises selecting one or more items of content from one or more content sources. Metadata associated with the one or more items of content is retrieved. Additionally, an index is constructed corresponding to the one or more items of content. The one or more items of content, associated metadata and index are stored in an accessible data structure according to a hierarchy. The accessible data structure is distributed and the contents of the accessible data structure are displayed.

### CROSS REFERENCE TO RELATED APPLICATION

This application claims priority to U.S. provisional application No. 60/728,041, entitled “SYSTEM AND METHOD FOR CREATION, DISTRIBUTION, AND UTILIZATION OF PORTABLE KNOWLEDGE FORMAT,” filed Oct. 17, 2005, the disclosure of which is hereby incorporated by reference herein in its entirety.

### CORYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

The present application is related to U.S. Pat. Ser. No. 10/211,937, entitled “Equipment Documentation Management System, Method, and Software Tools,” filed on Aug. 2, 2002, the disclosure of which is hereby incorporated herein in its entirety.

### BACKGROUND OF THE INVENTION

Content for conducting or supporting common business transactions is commonly published and distributed in a format that is inconsistent with how that content is used. As a result, content published from multiple sources often must be disaggregated, structured, and re-purposed in a format and structure that is aligned with how the content is subsequently used in a business process. This effort is time consuming and costly. Furthermore, users must add contextual information describing the content or sections of the content to ensure that the content or sections of content are accessible to those who need it in the context of how it is used and to what it pertains, such as in a work or other business process. This additional information describing the content is often referred to as metadata. Common content formats do not support the adequate storage of metadata and metadata structures to fully contextualize the relevance of content. As such, owners or users of content must add metadata to the file repositories that store the content, e.g., Document Management System (DMS).

Relying on a data repository to describe the content and context of content limits the creation of the content formats and relationships between content, often resulting in the bundling of content in an unstructured content format. Also, the lack of portability of content, along with the metadata and metadata structures outside of the native repository, increases the amount of human interpretation required to correlate content with work or business processes over the lifecycle of a process to which the information pertains. The result is time consuming, error prone, and inefficient business processes associated with the utilization of content. Solutions are needed to problems concerning the portability of content and metadata outside of native environments, as well as the interoperability of content and metadata across applications. Moreover, solutions are needed to provide recipients of content with a plurality of views of content and metadata in order to facilitate business processes.

With respect to manufacturing, Original Equipment Manufacturers (“OEM”) regularly develop and distribute documentation and technical data pertaining to equipment delivered to users (also referred to herein as owner/operators). Providing detailed and comprehensive documentation is often vital to the operation and maintenance of the equipment that OEMs develop and distribute. This holds true for a variety of other industries, including, but not limited to, insurance, health care, publishing, etc. Shortcomings in the art described with respect to manufacturing find analogs in many or all of these other industries.

Documentation that OEMs and other parties distribute along with equipment, products and services are delivered in either a hardcopy format as well as in a structured or unstructured electronic format. With respect to hardcopy formats, users are required to store the hardcopy in a safe location upon receipt so as to prevent damage, loss, etc. As the quantity and complexity of equipment, products and services increases, the amount of documentation to be stored by a user increases, requiring greater physical storage space in libraries, warehouses, or the like. Moreover, documentation currently delivered in hardcopy format is only accessible by a limited number of users at any given time, as physical possession of the hardcopy document is necessary in order to locate information within the document. For organizations that rely on such content, a substantial amount of time is wasted searching for information, whether through hard copy file systems or electronic file systems.

With respect to unstructured electronic documents, users currently receive extremely large files, or a grouping of files. While unstructured electronic documents allow a user to store documentation electronically, thereby reducing the amount of physical space in a warehouse or other storage facility, users are still presented with a large quantity of unorganized information making efficient retrieval of specific information difficult. Moreover, unstructured electronic documentation distributed to users often comprises a variety of file formats, thereby requiring users to maintain applications capable of finding and viewing the distributed documentation. Structured content commonly lacks the metadata that adequately describes the context for the information or how it will be used in the context of a work process. This again requires time consuming, error prone, and inefficient human intervention.

It is thus desirable for an OEM or organizations or other industries that maintain electronic documentation for distribution to users to do so according to a structured format that includes descriptive metadata, referred to herein as a Portable Knowledge Format (“PKF”). There is thus a further need for systems and methods that allow users to reduce the need to store voluminous documentation, such as equipment manuals, thereby allowing a plurality of users to access information concurrently.

### BRIEF SUMMARY OF THE INVENTION

The present invention provides a system and method for facilitating the movement of content (both digital and analog data) in a hierarchal, structured, and easily accessible structure. Content includes files and other media capable of being stored in an accessible memory structure including, but not limited to, text files, audio files and video files. Content may be stored on a variety of memory structures including databases, storage libraries, file systems and DMS applications. Content from a plurality of memory structures may be added to a PKF from an authoring environment. According to one embodiment, the content itself resides in the PKF. In other instances, the PKF stores links and metadata, accessing content over a network, such as the Internet, as required.

An authoring environment may be used to define file characteristics of and associations between content. Alternatively, the PKF may be generated directly from the memory structures through electronic means. Automated checking may be accomplished by processing for conformance with a predefined structure or schema.

Characteristics of and associations between content are created and stored as metadata that conforms to open standards, such as XML. According to one embodiment, the metadata are expressed in RDF, which is built upon XML technology. An index may also be created, which may include varying combinations of the content and metadata, to provide for efficient searching of the content and metadata. The index, metadata and content are packaged into a Portable Knowledge Format (“PKF”) for delivery to a user environment. A viewing environment provides a user with the capabilities to dynamically search and view data in an organized and hierarchal context with use of the metadata structures. Additionally, a workflow process may be defined external to a PKF, allowing enterprise applications to retrieve information from a PKF in conjunction with a given step in a workflow. Using metadata, a workflow process permits the retrieval of content from one or more PKFs for specific tasks, providing for the delivery of content to specified locations.

Embodiments of the present invention provide for extraction and/or definition of metadata that describes content to facilitate delivery of content in an indexed, hierarchal, and associated format. Through the use of metadata, users are able to view dependencies and relationships between various content. Additionally, through the definition and/or extraction of metadata, embodiments of the present invention permit users to add, update, suppress, annotate or delete (within any defined context or role for a given user that may be expressed in the metadata) content and metadata, as well as deliver updated content and metadata to additional users and systems. Moreover, embodiments of the present invention permit users to retrieve and review only content relevant to a specific use or need.

Embodiments of the present invention further provide systems and methods for the efficient retrieval and delivery of content to users in a format that provides users with efficient access to information. Through the use of metadata, indices may be created to provide users with structured searching capabilities across a plurality of items of content created according to a plurality of file formats. Embodiments of the present invention further provide for the structured completion of work processes. Through the use of a workflow that is external to the PKF, the present invention allows for the use of a workflow or work process to retrieve and deliver relevant content to a specified location, process or user.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a high-level block diagram depicting a system for the creation and delivery of a PKF according to one embodiment of the present invention;

FIG. 2 is block diagram depicting a PKF and its contents according to one embodiment of the present invention;

FIG. 3 is a block diagram depicting a system for the extraction of a PKF into a DMS according to one embodiment of the present invention;

FIG. 4 is a block diagram depicting a system for the delivery and viewing of a PKF according to one embodiment of the present invention;

FIG. 5 is a flow diagram illustrating a method for the creation of a PKF in an authoring environment according to one embodiment of the present invention;

FIG. 6 is a flow diagram illustrating a method for the delivery, viewing, and storage of a PKF in a user environment according to one embodiment of the present invention;

FIG. 7 is a flow diagram illustrating a method for the for the creation, delivery and use of a workflow in conjunction with a PKF according to one embodiment of the present invention;

FIG. 8 is a screen diagram illustrating a user interface for the authoring environment for the creation of a PKF according to one embodiment of the present invention;

FIG. 9 is a screen diagram illustrating a user interface for the addition of content to a PKF according to one embodiment of the present invention;

FIG. 10 is a screen diagram illustrating a user interface for the presentation of metadata, hierarchies among data and contents of a PKF in an authoring environment according to one embodiment of the present invention; and

FIG. 11 is a screen diagram illustrating a user interface for the content comprising a PKF and hierarchies among the data according to one embodiment of the present invention.

### DETAILED DESCRIPTION OF THE PREFERRED EMBODIMENTS

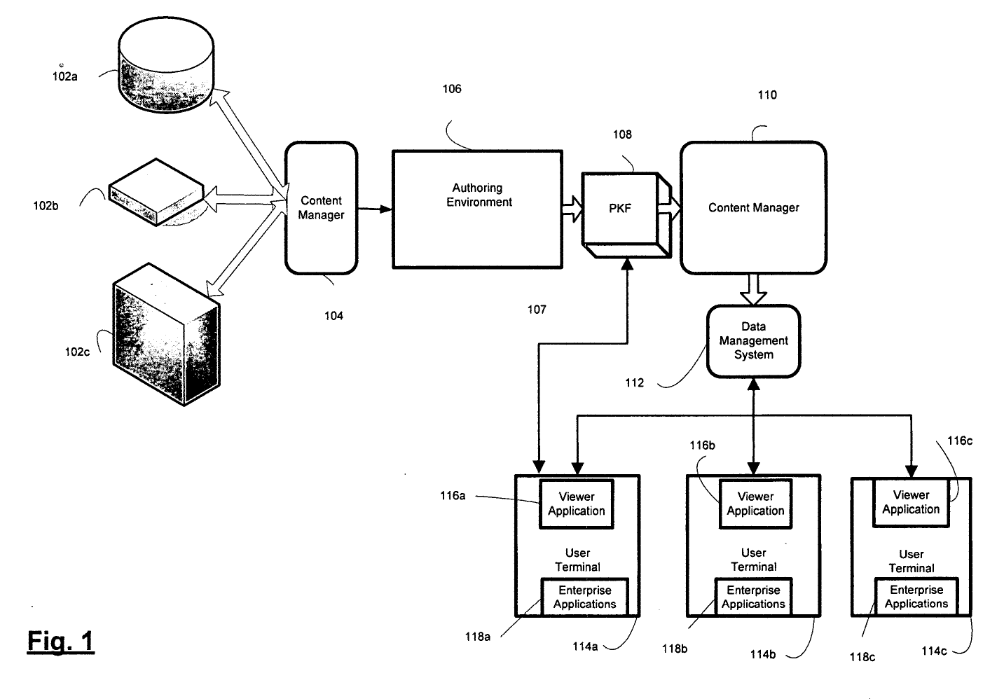

Embodiments of the methods and systems according to the present invention are described through references to FIGS. 1 through FIGS. 11. Turning to FIG. 1, a high-level block diagram depicts one embodiment of a system in accordance with the present invention for generating a Portable Knowledge Format (“PKF” ) from a collection of digital data content to be delivered to a user or application.

A PKF provides for the storage of content comprising various file formats in a structured, hierarchal, and indexed manner. The PKF comprises content, metadata that describes the content and an index that provides for searching the metadata and content. A recipient of a PKF may access the content that a PKF maintains through the use of an index and metadata. Dependencies and associations among content in a PKF are maintained through the use of metadata. Additionally, an index comprised of metadata is maintained to facilitate efficient searching. Recipients of a PKF may search the metadata index to locate and retrieve content rather than searching individual files.

As depicted in FIG. 1, content to be stored in a PKF may be stored according to variety of formats, structured or unstructured, from a plurality of disparate data content sources 102a, 102b and 102c. Data content sources 102a, 102b and 102c are accessible memory structures such as a database, CD-ROM, tape, digital storage library, etc. Content sources 102a, 102b and 102c may be implemented as databases or any other type of storage structures capable of providing for the storage and r etrieval of content. Data content sources 102a, 102b and 102c store a variety of file formats, including text files, graphical files, audio files, video files or other types of files known in the art and capable of being stored in an accessible memory structure. Data content sources 102a, 102b and 102c may also store files in an unstructured or structured manner. For example, structured content may comprise an entire manual for a given pump, stored in a single file in a data content source 102a with associated metadata. Alternatively, unstructured content may comprise various files stored in a plurality of content sources 102a, 102b and 102c in multiple file formats with no associated metadata.

Content sources 102a, 102b and 102c are communicatively coupled to a content manager 104 (e.g., over a network, such as the Internet) that receives requests from an authoring environment 106. Using an authoring environment 106, requests for content stored on various content sources 102a, 102b and 102c may be delivered to the content manager 104. The request for content from the authoring environment 106 is delivered to a content manager 104, which locates and retrieves the desired content from a respective content source 102a, 102b and 102c.

The content manager 104 is capable of retrieving a variety of file formats, including graphical files, audio files, text files, or other types files known in the art. The content manager 104 delivers the content retrieved from content sources 102a, 102b and 102c to the authoring environment 106. The metadata, which exposes associations and hierarchies among files and file elements, is created using open standards such as the Extensible Markup Language (“XML”). XML is a markup language that may be used to document metadata. The metadata defined by an RDF schema is written in an XML format and enforced by a Document Type Definition (“DTD”), which is referenced by other applications or systems to understand the semantics of the metadata. The PKF DTD provides a description of the structure of the PKF XML. Enterprise applications that understand that structure may extract metadata (XML-encoded RDF) for included content and presentation structures, such as nodes and filters. The RDF references RDF schemas that describe the relationships expressed in the metadata with a high degree of precision, helping machines to understand the data in a way that XML alone cannot. RDF schemas for common uses may be registered and available to users. Additionally, users may create their own RDF schemas to facilitate standardized use of the PKF within a unique environment.

One or more schemas may be associated with the content included in a given PKF and may be used to provide users with a plurality of views of the content within a PKF. According to one embodiment of the invention, a mapping is identified between the one or more schemas associated with the content included within a given PKF, or in some cases between schemas within the PKF and other schemas external to the PKF into which data from the PKF may be exported. For example, the one or more data elements comprising the Integration of Industrial Data for Exchange Access and Sharing schema may be mapped to the data elements comprising the Common Industry Material Identification Standard schema (CIMIS).

According to one embodiment of the invention, relationships between one or more data elements in the plurality of schemas associated with the content comprising a PKF are mapped according to a predetermined or newly created mapping. For example, the authoring environment 106 may identify a mapping between the data elements associated with the Dublin Core schema and the XmpLant schema, which may be based upon metadata in a PKF. According to another embodiment of the invention, a user of the authoring environment 106 may identify a mapping between the one or more schemas associated with a PKF. The one or more schemas that may be used by a PKF include, but are not limited to, the schemas illustrated in Table A. Mapping can either be deployed with a PKF is the mapping exists at the time of creation of the PKF, or generated subsequent to the authoring of the PKF. Furthermore, the mapping may be deployed outside the authoring environment, for example, to maintain ongoing synchronization when changes occur to one or more items of content.

TABLE A

| Schema abbreviation | Schema name |
|---|---|
| AEX | Automating Equipment information eXchange |
| CIMIS | Common Industry Material Identification |
| | Standard |
| GVCC | Global Valve Cross-reference eCatalog |
| ISO 15926/InfoWebML | Integration of life-cycle information for |
| | process plants, including oil and gas |
| | production facilities |
| ISO 18875/IIDEAS | Integration of Industrial Data for Exchange |
| | Access and Sharing |
| MIMOSA | Open information standards for Operations & |
| | Maintenance (MIMOSA) |
| PIDX | Petroleum Industry Data Exchange Committee |
| | (API) |
| PLIB | ISO 13584 - Parts Library Structure |
| STEP-AP221 | ISO-10303-221 Functional Data and |
| | Schematics for Process Plants |
| STEP-AP227 | ISO-10303-227 Plant Spatial Configuration, |
| | E.d. 1 & 2 |
| XMpLant | XML for plants based on ISO-10303-42 and |
| | ISO-15926-4 |
| aecXML | Architecture Engineering and Construction |
| | XML |
| AEX | Automating Equipment information eXchange |
| bcXML | Building and Construction XML |
| CIS/2 | CIMSteel Integration Standard, Version 2 |
| gbXML | Green Buildings XML |
| IFCs/BLIS | Industry Foundation Classes (IAI)/Building |
| | Lifecycle Interoperable Systems |
| ISO12006/IFD | International Framework for Dictionaries |
| National BIM | National Building Information Modeling |
| | Standard (NIBS) |
| oBIX | Open Buildings Information Exchange (oBIX) |
| OmniClass | OmniClass Construction Classification System |
| landXML | Integration of land use, infrastructure and GIS |
| | systems |
| Open GIS | Open Geospatial Consortium |
| OSCRE | Open Standards Consortium for Real Estate |

In addition to the plurality of schemas illustrated in Table A, one or more custom schemas may be generated for a given PKF. According to one embodiment of the invention, one or more custom schemas may be constructed using a combination of elements identified by one or more common standard schema in conjunction with and incorporating registry elements identified by a user of the authoring environment 106. For example, a user of the authoring environment 106 may supplement the CIMIS schema illustrated in Table A with one or more data elements to generate a schema comprising the elements desired by the user. According to another embodiment of the invention, one or more existing schemas, such as the plurality of common standard schemas illustrated in Table A, may be combined to construct a customized schema, which may incorporated user identified elements.

In accordance with one embodiment of the present invention, parsed files and file elements are stored in the original content source 102a, 102b, and 102c or may alternatively be stored in another database or accessible memory structure communicatively coupled to the authoring and/or viewing environment. In accordance with another embodiment of the present invention, only metadata generated in the authoring environment 106 is stored.

The authoring environment 106 examines the metadata of the file(s) retrieved and allows a user to view the plurality of files and file elements to be included with the PKF. According to one embodiment of the invention, the authoring environment 106 automatically extracts repeatedly used metadata items, such as metadata items identified in a schema or a hybrid of multiple schemas, e.g., the Dublin Core Metadata Element Set. For example, a given item may be requested from content sources 102a, 102b and 102c for inclusion in a given PKF. Upon receiving the item of content, the authoring environment 106 may automatically extract metadata items identified in one or more schemas. According to another embodiment of the invention, the authoring environment 106 provides the capability to supplement existing metadata or add new metadata to the content retrieved from a content source 102a, 102b and 102c.

The authoring environment 106 may further provide structured data models or templates to specify how information is to be presented when delivered to a user 114. The authoring environment 106 further permits a user to define views based on a schema, as well as generate one or more customized schemas, to allow recipients of the PKF to view a subset of the content delivered. A PKF author using the authoring environment 106 may allow for the creation of views (e.g., subsets of content and metadata in a PKF) using keywords, word strings, Boolean logic, etc. Users of the viewing environment may define views through ad-hoc filters that apply Boolean or other logic to content, metadata and/or combinations of metadata and content.

An index is created using the metadata retrieved and/or supplemented from data sources 102a, 102b and 102c, which may include accessing combinations of public and private data sources. Alternatively, the index may be created from the content itself. For example, the index may comprise a word/location index. Accordingly, content is indexed against the location in which the word or phrase appears.

The metadata, structured content, and index are maintained as a PKF 108. In accordance with one embodiment of the present invention, a PKF 108 may be delivered via a communication means, such as the Internet, to a content manager, e.g., an Asset Content Manager (“ACM”) 110, described in U.S. Pat. Ser. No. 10/211,937, which is herein incorporated by reference in its entirety. Upon receiving a PFK 108, the content manager 110 stores the PKF 108 in its entirety. According to one embodiment of the invention, the contents of the PKF 108, including the metadata, are extracted into one or more DMS applications 112. The DMS 112 is communicatively coupled to one or more users 114a, 114b and 114c, which may request content from a PKF 108 or entire PKFs. According to another embodiment of the invention, a mapping may be maintained between the ACM system and one or more PKFs to allow a user to interact with the PKFs and obtain information updated from the ACM system.

The inter-schema mapping may also be used for the purpose of causing the automatic or systematic updating of the information in the PKF to reflect changes in the ACM system data. The metadata associated with a given PKF may be utilized to extract or map data within a given PKF to the ACM system. According to yet another embodiment of the invention, a mapping may be maintained between one or more PKFs and the master data associated with one or more applications maintaining content. Similarly, a mapping may be maintained between the one or more schema elements comprising a given schema associated with a PKF and the master data associated with one or more applications maintaining content. The mapping maintained between a PKF and the master data associated with one or more applications allows a user to interact with the PKF in order to retrieve information that may be updated or modified within an application's master data.

Content may be displayed on user terminals 114a, 114b and 114c by means of a viewer application 116a, 116b, and 116c. A viewer application 116a, 116b, and 116c examines the metadata associated with content requested from a PKF. A viewer application 116a, 116b, and 116c retrieves the requested content, which may include the retrieval of any associated content as indicated by the metadata to thereby allow for the retrieval of related content. According to one embodiment of the present invention, the viewer 116a, 116b, and 116c invokes enterprise applications 118a, 118b, and 118c available to a user to display content. For example, to display a PDF file, a viewer 116a, 116b, and 116c may invoke Adobe Acrobat, and display the PDF file within the viewer application. According to another embodiment of the present invention, plug-in modules are used to supply functionality for rendering the content, delivering the rendered content to a viewer 116a, 116b, and 116c for display in the viewing application.

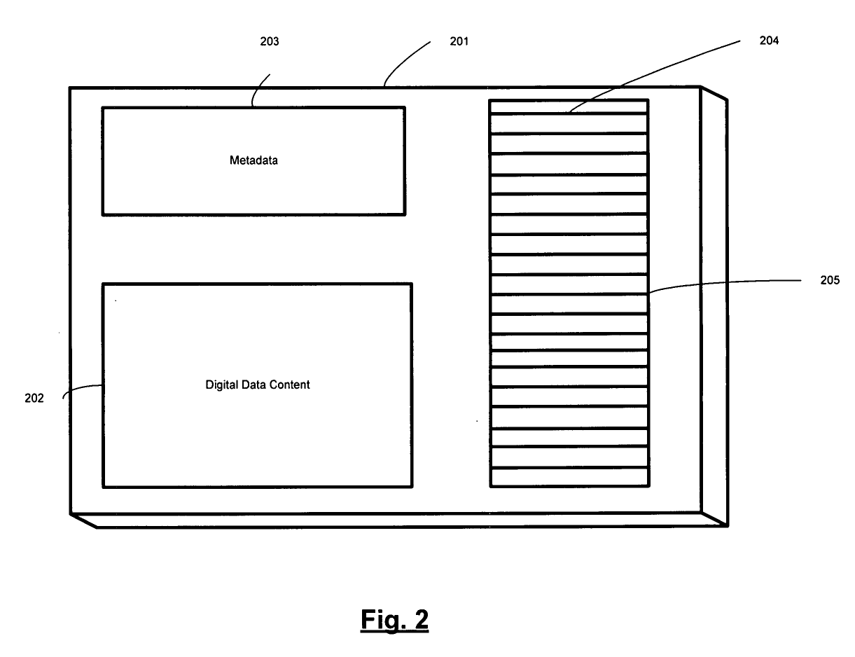

Turning to FIG.2, a block diagram illustrates one embodiment of a PKF 201. PKF 201 maintains content 202 comprising data to be delivered to a user. The content 202 of a PKF 201 contains files encoded according to various file formats, including, but not limited to, text files, audio files, PDF files, HTML file, XML files, video files, etc. An authoring environment, whereby metadata 203 is extracted from the content or defined by a user of the authoring environment, retrieves the content 202 contained within a PKF 201. For example, the authoring environment may automatically extract commonly used metadata elements, such as title, creator, subject, description, date, etc. (which may be identified by a schema) and use the extracted metadata to identify the content comprising a PKF or one or more nodes within the PKF. The schemas associated with a PKF may be supplied as part of the PKF or referenced externally. Additionally, a mapping may be generated between the one or more schemas associated with a PKF to provide for a plurality of views of the content within a PKF.

The metadata 203 comprises the metadata extracted from the digital data content as well as metadata specified by a user of the authoring environment. The metadata 203 corresponds to given items of content 202, providing information on associations and hierarchies among the content items 202. Each file or file element delivered with a PKF 201 has associated metadata 203 in order to display the file or file element in a proper context. Viewing and enterprise applications in a user environment access the metadata 203 delivered with a PKF 201. The metadata 203 may be used to properly display content 202 to users in a structured manner. For example, using one or more schemas associated with a PKF, a user may view all content delivered with a PKF 201 in a graphical tree structure, indicating relationships and dependencies among the content. Alternatively, a user may request content on a specific topic and the viewer and enterprise applications, accessing the PKF metadata 203 and the one or more schemas associated with a PKF display content from the PKF pertaining to the topic requested, which may also include content associated with the content requested. Moreover, when a user views content 202 delivered in a PKF 201, a user may alter (e.g., add, change, suppress, delete) the associations between files and file elements, as well as add, change, suppress, annotate or delete content and associated metadata. The metadata 203 component of a PKF 201 is used to store user updates to file associations. Furthermore, user authorization levels may determine what specific functions or alterations a given user may perform.

The index 204 contains information to provide a recipient of the PKF 201,which may be a user or an application, with the ability to efficiently search the PKF 201. According to one embodiment of the present invention, the index 205 comprises terms and phrases found in the metadata 203, for example, the index elements 205 comprise word/location pairs indicating the files in which a given word appears. According to another embodiment of the present invention, the index elements 205 comprise a combination of metadata 203 and words from the content 202. According to yet another embodiment of the present invention, the index 204 comprises links, allowing a user to access both content 202 within a PKF 201, as well as information outside a PKF 201, such as information contained in other PKFs. The index 204 provides a recipient of the PKF 201 the ability to search the digital data content 202 at a PKF level rather than at an individual file level, thereby allowing for efficient searching and rapid retrieval of content. Moreover, changes made by a user to the metadata 203 may be propagated to the index 204 in order to maintain a proper record of associations between files and file elements.

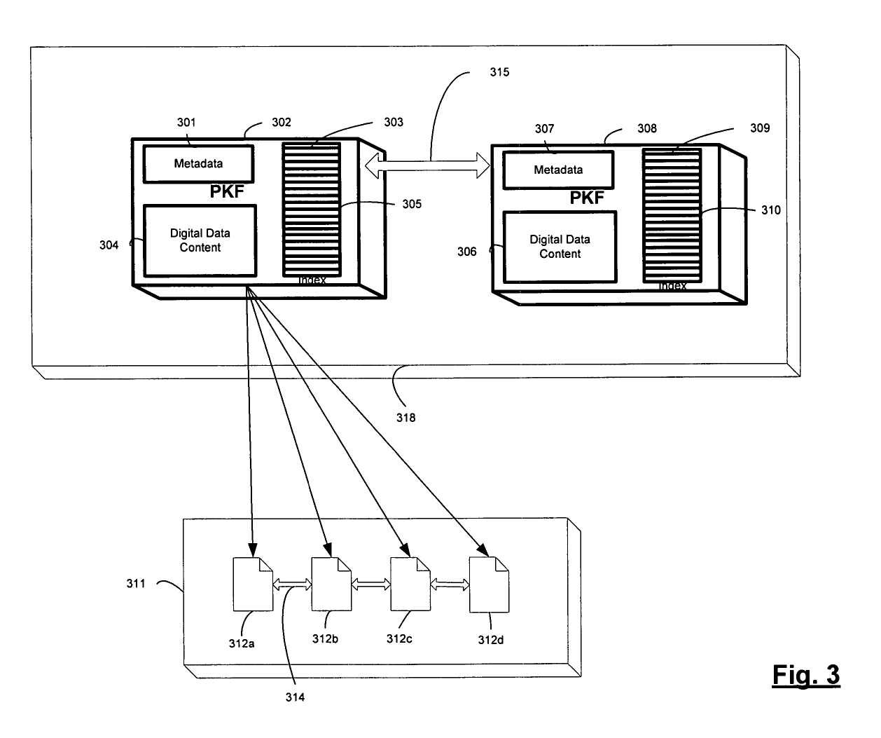

FIG. 3 provides a block diagram depicting one embodiment of a content manager storing a PKF. A PKF 302, 308 is delivered to a content manager 318 which determines whether to extract the components of the PKF 302, 308 into a DMS 311 or whether to store a PKF 302, 308 in its entirety. As seen in FIG.3, the content 304, metadata 301 and index 303 of PKF 302 are extracted into a DMS 311. Storing the elements comprising a PKF 302, specifically, the content 304, metadata 301 and index 303, preserves relationships and dependencies 314 among content files 312 when extracted to the DMS 311. Moreover, storage of the metadata 301 and 307 preserves associations between multiple PKFs, e.g., PKF 302 and PKF 308. Additionally, storage of the index 303 allows a user seeking information stored in a PKF 302, 308 to gain access to the desired content with speed and efficiency. The index 303 delivered with a PKF 302 provides a user with the ability to search at the PKF level rather than searching among the numerous content files individually.

The maintenance and storage of the metadata 301 permits a PKF 302 to be reconstituted if needed. As noted, by storing the metadata structures 301, relationships and dependencies 314 among content files 304 are preserved. Enterprise applications have access to the PKF DTD that describes the PKF XML format, as well as to the RDF schemas referenced by the PKF, thereby allowing the enterprise applications to read the metadata 301 and acquire knowledge about relationships among the various content files 304. Access and maintenance of metadata 301 allows for the distribution of the content 304 in an organized, structured, and hierarchal manner. Additionally, preservation of the relationships 314 between content files 304 allows the extracted content files 304, metadata 301, and index 303, to be repackaged into a PKF 302, thereby allowing delivery to additional content management 318 systems. In accordance with one embodiment of the present invention, a PKF may also be delivered directly to a user. A user environment may store the elements comprising a PKF, including the metadata, content, and index. A user environment has access to the PKF DTD and to RDF schemas referenced by the PKF, allowing applications within a user environment to process and maintain associations among content files.

While the embodiment illustrated in FIG. 3 presents the extraction of a PKF into a DMS, according to another embodiment of the invention, a PKF may also be delivered directly to a user environment while maintaining a mapping with a content management system. According to one embodiment of the invention, a content management system may utilize the metadata within a PKF to maintain a mapping with the PKF. The mapping may be used to update content items within the PKF, modify associations or dependencies among the content items within the PKF, etc. According to one embodiment of the invention, the mapping maintained between a given PKF and a content management system comprises an indication to copy relevant information maintained within the content management system to the PKF. According to another embodiment of the invention, the mapping maintained between a PKF and a content management system comprises one or more links within the PKF to information maintained in the content management system.

The mapping maintained by a PKF to information that resides in a content management system allows a recipient of a PKF to interact with the local PKF in order to obtain desired information. For example, a given PKF may contain content on a manufacturer's recommended steps for performing proper maintenance on a given vehicle. The PKF maintains a mapping to the relevant information in the content management system, which may be delivered to a user environment. The vehicle manufacturer may thereafter modify the content associated with the recommended maintenance steps in the content management system. Rather than delivering an updated PKF or requiring the user to locate the updated information within the content management system, the mapping maintained by the PKF allows the user to retrieve the manufacturer's modified information. The user may interact with the local PKF and request the desired information, which results in the retrieval of the modified information using the mappings between the PKF and the content management system.

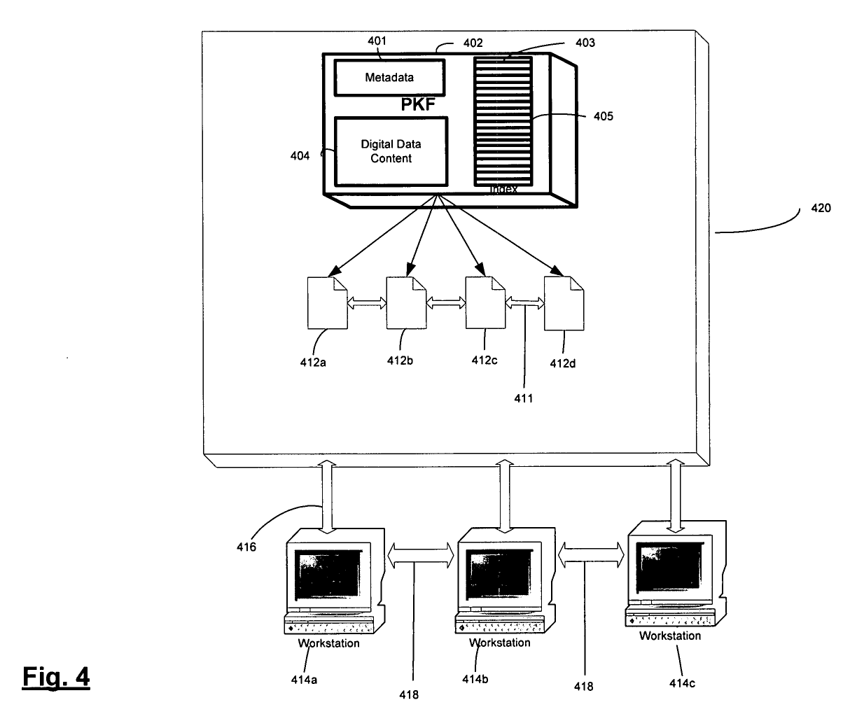

FIG. 4 provides a block diagram depicting one embodiment of a system for viewing and updating the contents and metadata of a PKF. In accordance with one embodiment of the invention, a PKF 402 may be delivered to a content manager, and thereafter, extracted into a DMS 420. In accordance with another embodiment of the invention, a PKF may be delivered directly to a user within the context of a work process (automated discovery on the basis of metadata interpretation) or upon request (manual request with electronic delivery).

User environments 414, communicatively coupled 416 to the DMS 420, may make requests for content to the DMS 420 using a viewer located in the user environment 414. A user request is processed using the index 403 delivered with a PKF 402. A search of the index 403 is performed to locate content that is responsive to a user request 404. The content 412 located is delivered to a user via a communication means 416. The content 404 delivered to a user 414 may be comprised of various file types, each requiring different applications to properly display the content. The viewer reviews the metadata structures 401 associated with the respective content 404 to determine the type of content delivered and the application(s) needed to properly display the content 404 to a user 414. In accordance with an embodiment of the present invention, the viewer invokes the necessary application and displays the requested content to a user within the viewer application. In accordance with another embodiment of the present invention, a plug-in module is used to apply rendering to the requested content and deliver the rendered content to the viewer for display to a user. Additionally, a viewer allows a user to graphically expose the relationships or associations 411 among the content in a PKF 402 to gain knowledge as to the structure, hierarchies, and associations of the digital data content 404.

In accordance with one embodiment of the present invention, a user presented with the requested content may review and modify the content received, including associated metadata. In accordance with another embodiment of the present invention, a user may modify the metadata 401 associated with the content received to define new descriptions of the content, as well as associations and hierarchies 411 among the content. The modifications made to the content 404 or metadata 401 may be stored in a PKF or in the DMS 420. Additionally, changes made to the metadata 401 are reflected in the index 403 in order to maintain efficient access and retrieval of content 404. Content can be added, updated, suppressed and deleted, and additional metadata may be added, updated, suppressed and deleted. If a PKF 402 is reconstituted, the updated content 404, index 403, and metadata 401 are incorporated within the reconstituted PKF 402 and may be delivered to additional DMS 420 environments. Additionally, a user communicatively coupled 418 to other users, for example via a LAN, may send the updated PKF to additional users 414 .

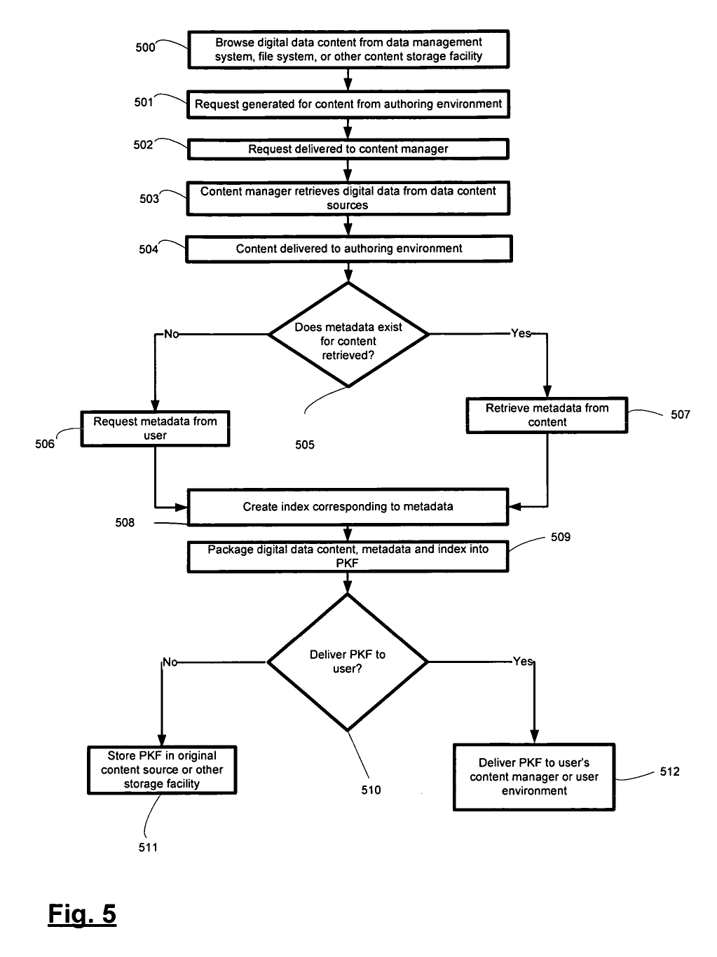

One embodiment of a method for generating a PKF using an authoring environment is illustrated in the flow diagram of FIG.5. A user of the authoring environment may browse and retrieve digital data content from various data storage facilities including databases, indexes of hard copy files, CD-ROMs, servers, the Internet, DMS applications, or hard disks, step 500. In accordance with the embodiment of FIG. 5, a request is received for digital data content using an authoring environment, step 501. A request may be manually entered by a user, generated by an application or automatically generated according to systems and methods described below, or a combination thereof. The authoring environment delivers the request to a content manager, step 502. The content manager determines the location of the requested content among the plurality of content sources, step 503 .

Upon locating the desired digital data content from the respective content source, the content is delivered to the authoring environment, step 504. Content delivered to the authoring environment may be structured or unstructured content. For example, structured content may comprise an entire manual in PDF format consisting of several hundred pages with associated metadata (a parts book is one example of structured content), while unstructured content may comprise numerous image files, text files, audio files, hardcopy files, etc., stored in separate locations, which may or may not contain associated metadata.

Included in the authoring environment are many functions/features for processing the data to extract and define metadata. The processing performed in the authoring environment includes the extraction and definition of metadata and creation of hierarchies and dependencies. The authoring environment parses files and file elements to determine whether metadata exists, step 505. If metadata exists for the file being parsed, the relevant metadata is extracted, step 507 . For example, a file may contain many different types of elements such as graphical elements and textual elements that require different processing to convert into structured content. The authoring environment extracts and associates metadata with a graphical element to indicate, for example, the name of the graphical element, the description of the graphical element, a description of where or how the element is typically used, links to other documents or other parsed elements, associations with other elements or files, etc. Additionally, the authoring environment may provide for the automatic extraction of frequently used or user specified metadata items. For example, the authoring environment may provide for the automatic extraction of Dublin Core Metadata elements. The one or more Dublin Core Metadata elements extracted from a given file may be utilized to identify the content within a PKF, as well as the relationships and dependencies among the one or more items of content in the PKF, or to references external to the PKF. Moreover, the authoring environment may automatically map the one or more metadata elements extracted from a given file to one or more schemas, providing recipients of the PKF with a plurality of views of the content within a PKF.

If metadata does not exist for a particular file or file element, the authoring environment prompts a user or application to define metadata, step 506. A user of the authoring environment may also define associations between files and file elements, as well as specify how data is to be displayed in a user environment. Metadata structures and conventions from multiple disparate sources may also be accessed and used by the authoring environment.

In accordance with one embodiment of the present invention, as a file is parsed, elements may be stored in a content database or other accessible memory structure. In accordance with another embodiment of the present invention, the authoring environment may store only metadata associated with a parsed file or file element.

As described above, metadata is extracted from the data received from a content source or defined by user input, step 507 and 506, respectively. The metadata extracted, step 507, or input, step 506 is written to an XML file, the structure of which may be defined by a DTD or one or more RDF schemas. Upon extracting and defining metadata, an index is created, step 508. In accordance with one embodiment of the present invention, an index is created using the extracted and defined metadata. In accordance with an alternative embodiment of the present invention, a word/location index is created, whereby content is indexed against the location in which a word or phrase appears. The index provides a user with the ability to search content at a PKF-level in addition to searching at an individual file-level.

The index, metadata, and content are packaged into a PKF, step 509. The authoring environment determines whether to deliver the PKF to a content manager or user environment or whether to store the PKF in a storage facility, step 510. In accordance with one embodiment of the present invention, upon creation of the PKF the authoring environment delivers the PKF to a content manager, user environment, or other user storage facility, step 512. In accordance with another embodiment of the present invention, the authoring environment stores the PKF in an OEM's storage facilities, step 511, and upon receipt of a user request, delivers the PKF to the appropriate user.

According to one embodiment of the present invention, requests for documentation may be received from users or purchasers of an OEM's equipment via a communication medium such as the Internet. If a request is received from a user, and a PKF for a user's request has already been constructed, the PKF corresponding to a user's request may be retrieved from a storage facility and delivered to the user via a communication means such as the Internet. Alternatively, if an OEM receives a request, and a PKF has not previously been constructed for the user's specific request or equipment, a PKF can be dynamically constructed using the authoring environment system and method described above.

Within the context of manufacturing, which those of skill in the art should recognize finds analogs in many other industries, the purchaser of equipment provides a PKF “template” with metadata “slots” to be filled out by the OEM for a given item of contracted equipment. Each metadata slot is described by a reference to a property in one or more RDF Schemas whereby the one or more schema properties determine what a given slot may validly contain (a schema property is a combination of textual description and syntactic prescription). Schemas may be supplied in the PKF, or the PKF may reference an external schema. One or more mappings may be generated to associate the one or more schemas associated with a given PKF. The OEM returns the PKF to the purchaser with metadata supplied in these slots—typically describing and qualifying the content that the OEM has inserted into the PKF. The one or more schemas may provide the purchaser with a plurality of views of the content within the PKF.

The OEM may use a PKF editing tool to fill in these slots. Because the PKF format is defined using open standards, however, the OEM may also generate the PKF. For example, the OEM may generate the PKF with other software that automatically inserts the required content and metadata into the purchaser's “template”. Accordingly, the resulting document comprises self-validating properties as it contains all of the information necessary to ensure that the returned PKF constitutes a valid response to the original request.

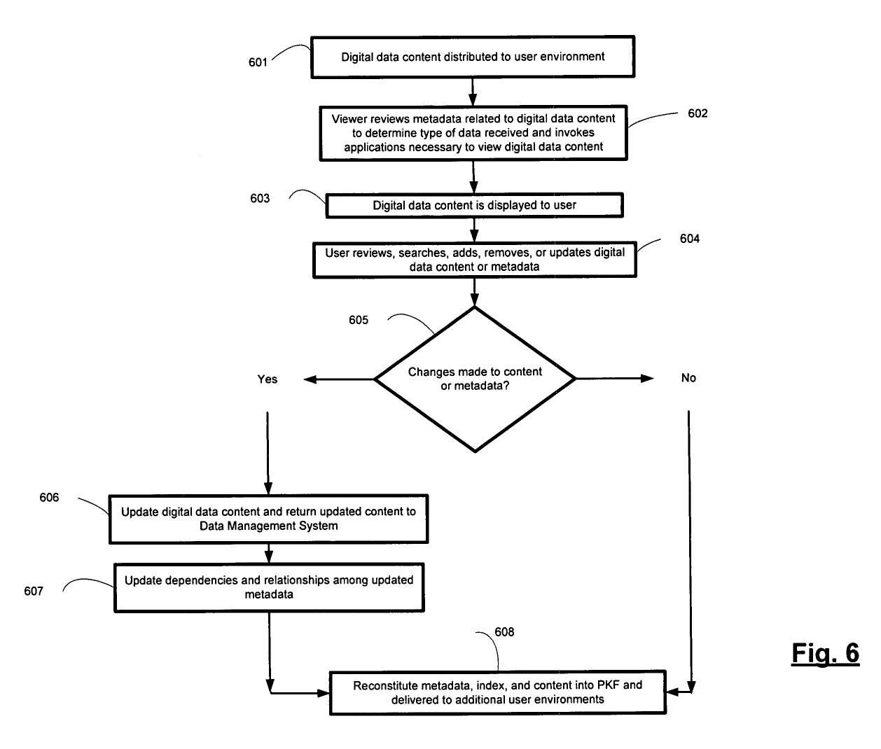

FIG. 6 provides a detailed flow diagram depicting one embodiment of a method for viewing a PKF in accordance with the present invention. As previously described, the components of a PKF may be extracted into a DMS. Alternatively, a PKF may provide linkages to content found elsewhere to thereby allow the use of a single master set of content and eliminate the need for publishing “files”. Using a viewer module, a user communicatively coupled to the DMS makes requests for content to the DMS system. Using the metadata and index delivered with a PKF and extracted into the DMS system, a user can search content stored in the DMS. Based upon a user's request, content stored in a DMS is delivered to a user, step 601. Alternatively, the user may search the index of the PKF to directly access the content contained in the PKF. Similarly, where the PKF comprises links to content, a given link may be traversed to locate the linked content.

The viewer module, upon receiving the requested content, reviews the metadata structures associated with the content delivered 602. The metadata delivered with the content from a PKF permits the viewer module to determine the type of file requested, associations with other files in the PFK, as well as associations with other PKFs, step 602. For example, the content delivered with a PKF may contain PDF files, Microsoft Word files, GIF files, XML files, HTML files, etc. The viewer, using the metadata structures associated with a file or a plurality of files, invokes a universal viewer or the relevant application to display the content requested, step 603, and provides a user with the ability to navigate and retrieve associated files. According to one embodiment of the present invention, the viewer invokes the relevant enterprise application to display the content requested in the viewing environment. According to another embodiment of the present invention, a plug-in rendering module is used to render the content and display the content in the viewer.

When the respective application or plug-in displays the content requested by a user, a user is capable of reviewing and modifying the content 604. In accordance with one embodiment of the present invention, upon reviewing the content requested, a user may locate additional content associated with the content received 604. Additional content may be located using the associations defined with the metadata delivered with a PKF. In accordance with another embodiment of the present invention, a user may add, update, annotate or remove content received, as well as add, suppress and delete file views and metadata for a given PKF. According to one embodiment, annotations do not affect the original content unless authorizations allow for such. Furthermore, a workflow process enables annotations to be routed back to authors for updating of original content as required. In accordance with another embodiment of the present invention, a user may modify the associations defined by the metadata, creating new associations, dependencies, and hierarchies. In accordance with yet another embodiment of the present invention, a user may graphically expose the relationships among the content of a PKF using the metadata structures delivered with a PKF.

After reviewing, updating, or modifying the content or metadata, the system determines whether the user has made any changes to the content or metadata, 605. If changes were made, the content and changes are returned to the DMS, which stores the updated content, metadata, and index 706. Similarly, the changes to content and metadata may be written back to a PKF. Dependencies and relationship among the metadata and content are updated, step 607. If changes to the metadata or content were not made, no updates are made in the DMS or to the PKF. As discussed above, a PKF may be reconstituted after extraction into a DMS. A reconstituted PKF will incorporate changes made by a user in the viewing environment 606. A reconstituted PKF, with updated content and metadata, may be delivered to additional users or user environments, as well as new data repositories, e.g., a DMS, step 608.

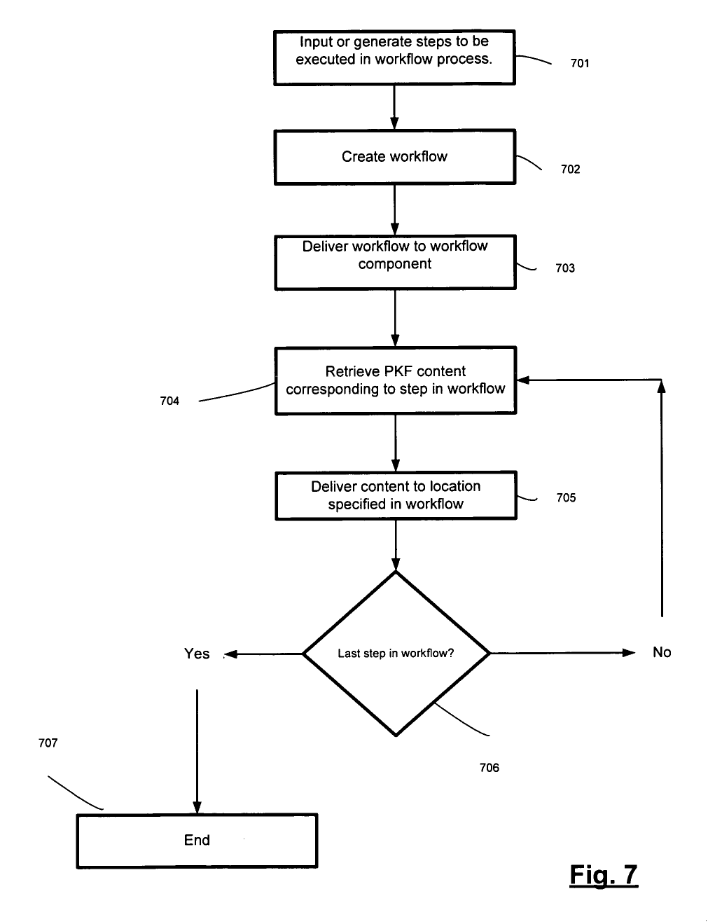

FIG. 7 presents a flow diagram depicting one embodiment of a method according to the present invention for using a PKF in the context of a work process or workflow. A workflow component is incorporated in a user environment, which may be incorporated via the use of a plug-in or a helper application. According to one embodiment of the present method, a user inputs steps to be executed in a workflow, step 701. According to another embodiment of the present invention, a workflow is automatically generated for a particular task or series of tasks.

Using the steps entered or generated, a workflow is created, step 702. A workflow contains a series of steps defining a work process. For example, a work process may indicate the type of data needed for a work process, a location to deliver the relevant data, or a time for data to be delivered. A workflow is delivered to a workflow component, step 703. Using the metadata describing the PKF and its contents, enterprise applications can retrieve a PKF(s) or content from a PKF related to a particular task, step 704, and deliver the PKF or content to the location specified in a workflow, step 705.

A workflow may be created with a variety of enterprise applications or through the use of a plug-in. A workflow component receives a workflow and examines the contents to determine the process to execute, step 703. For example, a workflow may specify data to be retrieved from a PKF or a particular PKF to retrieve, step 704. Accordingly, content stored in a DMS or the PKF may be retrieved and delivered to a user environment for display in a viewer, step 705. Alternatively, content may be retrieved and delivered using one or more links in the PKF. According to one embodiment of the present invention, a user or recipient of content in the workflow process can alter the workflow. For example, a user may receive content from a PKF and determine that a step in the workflow is not needed or must be added. A user can modify the workflow, inserting or removing the work process as needed. Upon completion of the user's task, the workflow proceeds to execute the next process in the workflow, step 706.

A workflow may specify a particular PKF to retrieve from the DMS and to deliver the PKF to a specified user. A workflow may further instruct a first user to deliver content or an entire PKF to a second user based upon the first user's interaction with the PKF. Additionally, a workflow may execute according to decisions or interactions a user has with a PKF. For example, if a user modifies a particular PKF, the workflow may deliver the relevant PKF to a manager for approval. Alternatively, if user merely reviews and annotates a PKF, the workflow returns the annotated PKF to the DMS or delivers the PKF to another user.

A workflow may also retrieve a particular PKF based upon the respective step or task being processed or executed in the workflow. For example, a workflow created for an assembly line may specify the particular PKF to retrieve based upon the product being constructed and the particular task being executed. According to another embodiment of the present invention, a workflow is executed as a hidden process. Content is delivered to a user, however, any user in the workflow process, according to one embodiment, cannot modify the work process. A workflow is executed until all steps in the workflow process are complete, step 707. According to yet another embodiment of the present invention, a workflow may grant control to a select group of users. For example, managers or system administrators may have authority to modify a workflow. When control is granted to a user with authority to modify the workflow, the authorized user may specify additional processes to be added to the workflow or processes to be removed. Additionally, a user with authorization may terminate the workflow or specify conditions or events to terminate the workflow.

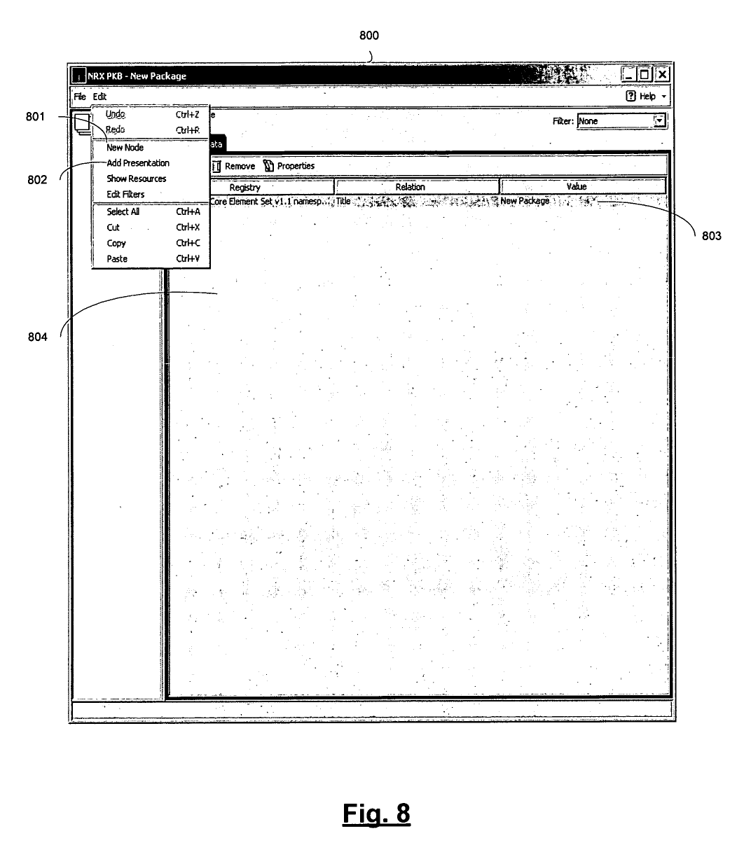

FIG. 8 presents a screen diagram illustrating one embodiment of an interface to an authoring environment for a PKF. The authoring environment 800 allows a user to retrieve content from content sources and extract and define metadata associated with the content retrieved. A user can create a hierarchy among the content retrieved by adding a node 801. Similarly, hierarchies may be automatically identified by the authoring environment 800 based upon metadata, which may be metadata associated with the one or more items of content retrieved. As known by those with ordinary skill in the art, a node represents a dependency or association with a parent node or child node. In the authoring environment, creation of a node 801 allows a user to specify the association and dependency with respect to a particular file or file element. Alternatively, or in conjunction with the foregoing, the authoring environment 800 automatically identifies associations and dependencies upon creation of a node 801.

A user may also add content to a PKF using a toolbar button or menu item 802. When a user selects this function, he or she is able to browse a plurality of content sources to retrieve a specified file or file element. The content retrieved is delivered to the authoring environment and parsed, which may be accomplished using the authoring environment. The authoring environment extracts metadata associated with the file or file element. The metadata extracted is displayed to a user of the authoring environment 803. Additionally, a user may specify additional metadata to be added to a file or file element. As content is selected for inclusion in a PKF, the contents are presented to the user of the authoring environment in the display area, 804.

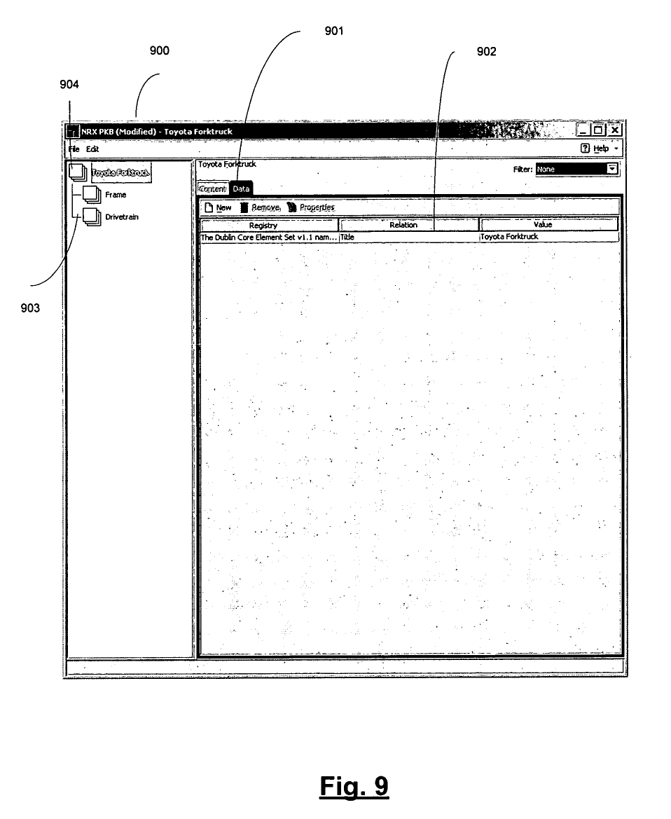

FIG. 9 presents a screen diagram illustrating one embodiment of an interface to an authoring environment for viewing the content added to a particular PKF. The authoring environment 900 displays the contents added 902 to a PKF. Selecting the “Data” tab 901 allows a user to view the metadata 901 extracted from or added to the content retrieved from a content source. A user of the authoring environment may also view the dependencies and associations 903 among the content added to a PKF. As depicted in FIG. 9, “Toyota Fork truck” is the parent node of “Frame” and “Drivetrain.” “Frame” and “Drivetrain” comprise sub-contents of “Toyota Fork truck.” A user may view the type of content added to the PKF 904. Various icons 904 may be displayed according to the type of file or file element. Icons are representative of file or element type.

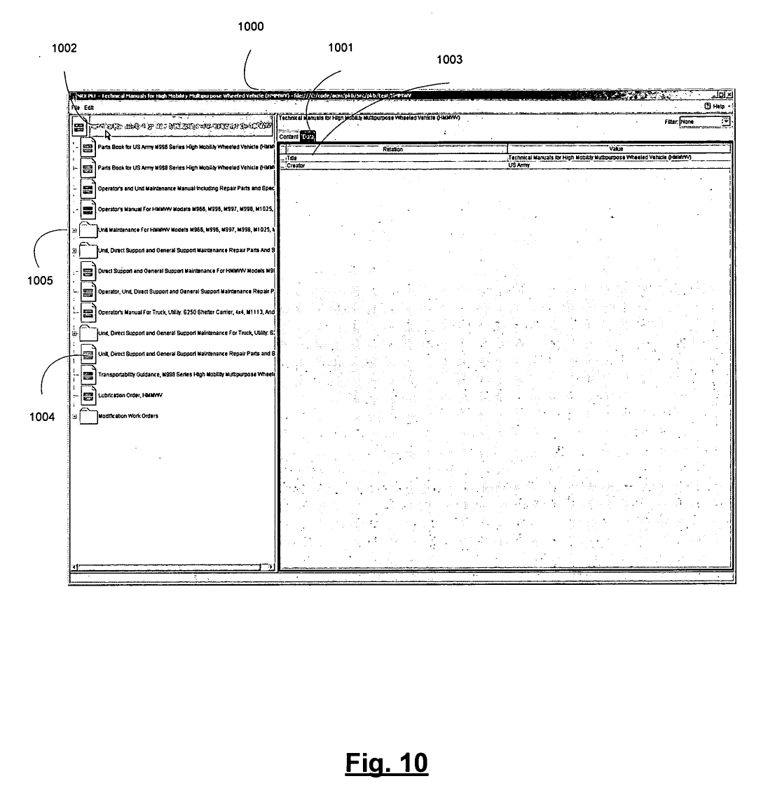

FIG. 10 provides a screen diagram illustrating one embodiment of an interface for displaying the contents of a PKF in an authoring environment. A user of the authoring environment 1000 can display the metadata associated with a particular file or file element by selecting the “Data” tab 1001. As shown, metadata associated with the selected node 1002, title and creator 1003, is displayed by selecting the “Data” tab 1001. The authoring environment further provides a user with the ability to add additional metadata.

FIG. 10 further depicts the various file formats that are incorporated in a given PKF. As shown, icons displayed reflect content type 1004. Additionally, associations among files are depicted in a hierarchal manner. A user of the authoring environment may click on the ‘+’ symbol to display associated files 1005.

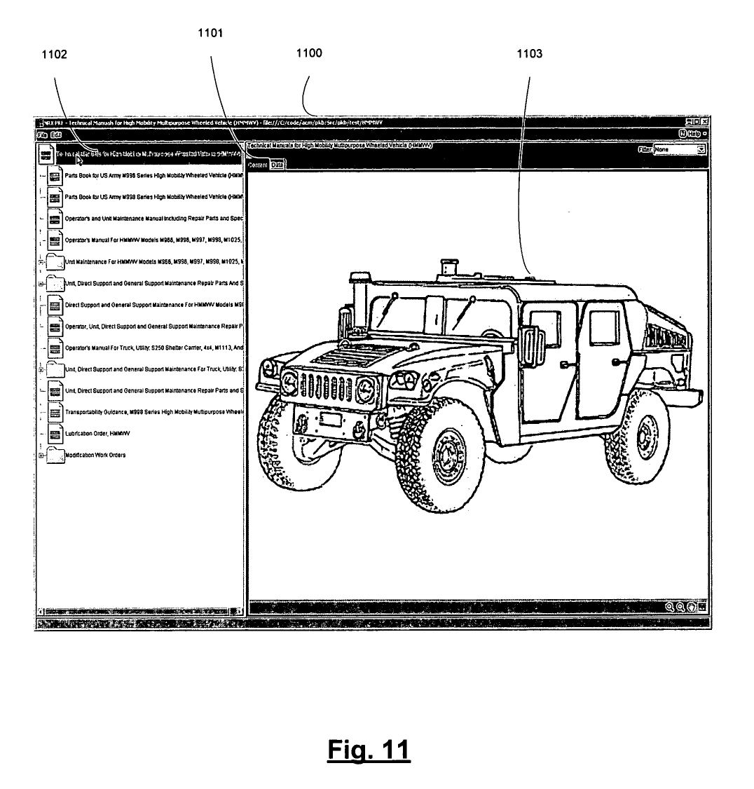

As shown in FIG. 11, a user of the authoring environment 1100 may view the contents included in a PKF. Selecting the “Content” 1101 tab displays the contents of the file or folder selected 1102. Additionally, file elements, such as images, which are associated with certain content through the use of metadata, may be displayed in the authoring environment 1103.

Attached at Appendix A is exemplary XML code describing the PKF constructed from the authoring environment as illustrated at FIGS. 8 through 11.

While the invention has been described and illustrated in connection with preferred embodiments, many variations and modifications as will be evident to those skilled in the art may be made without departing from the spirit and scope of the invention, and the invention is thus not to be limited to the precise details of methodology or construction set forth above as such variations and modifications are intended to be included within the scope of the invention.

1. A method for facilitating the distribution of content in an accessible data structure, the method comprising:
selecting one or more items of content from one or more content sources;
retrieving metadata associated with the one or more items of content;
constructing an index corresponding to the one or more items of content;
storing the one or more items of content, associated metadata and index in an accessible data structure in accordance with a hierarchy;
distributing the accessible data structure; and
displaying the contents of the accessible data structure.

2. The method of claim 1 wherein selecting one or more items of content comprises selecting one or more items of structured or unstructured content from one or more data content sources.

3. The method of claim 2 wherein selecting structured content comprises selecting content stored according to a defined structure with associated metadata.

4. The method of claim 2 wherein selecting unstructured content comprises selecting content stored according to an undefined structure, with or without associated metadata.

5. The method of claim 1 wherein retrieving metadata associated with the one or more items of content comprises automatically extracting metadata associated with the one or more items of content.

6. The method of claim 1 wherein retrieving metadata associated with the one or more items of content comprises receiving user input that identifies metadata associated with the one or more items of content.

7. The method of claim 1 wherein retrieving metadata associated with the one or more items of content comprises retrieving metadata according to one or more schemas.

8. The method of claim 7 wherein retrieving comprises retrieving according to one or more common standard schemas.

9. The method of claim 7 wherein retrieving comprises retrieving according to one or more user identified schemas.

10. The method of claim 1 wherein constructing an index corresponding to the one or more items of content comprises constructing an index of word/location pairs corresponding to the one or more items of content.

11. The method of claim 1 wherein constructing an index corresponding to the one or more items of content comprises constructing an index of the metadata associated with the one or more items of content.

12. The method of claim 1 wherein storing comprises constructing a portable knowledge format comprised of the one or more items of content, the associated metadata and the index.

13. The method of claim 1 wherein storing comprises storing the content, metadata and index in an accessible data structure in accordance with a hierarchy identified by the metadata.

14. The method of claim 1 wherein storing comprises storing the content, metadata and index in an accessible data structure in accordance with a user identified hierarchy.

15. The method of claim 1 wherein distributing the accessible data structure comprises distributing to a client device.

16. The method of claim 1 wherein distributing the accessible data structure comprises distributing to a data management system.

17. The method of claim 1 wherein distributing the accessible data structure comprises distributing the one or more items of content, associated metadata and index via the Internet.

18. The method of claim 1 wherein distributing the accessible data structure comprises distributing in response to a request.

19. The method of claim 1 wherein distributing the accessible data structure comprises distributing automatically to one or more predetermined locations.

20. The method of claim 1 wherein displaying the contents of the accessible data structure comprises displaying in one or more viewing environments.

21. The method of claim 20 wherein displaying in one or more viewing environments comprises displaying the metadata and content comprising the accessible data structure according to one or more schemas associated with the accessible data structure.

22. A system for facilitating the distribution of content in an accessible data structure, the system comprising:
a content manager operative to receive a request for content and retrieve content from one or more content sources in response to the request;
an authoring environment operative to:
receive one or more items of content from the content manager;
extract and define metadata for the one or more items of content received;
construct an index for the one or more items of content;
store the content, metadata and index in the accessible data structure; and
distribute the accessible data structure; and
a viewer operative to display content comprising the accessible data structure.

23. The system of claim 22 wherein content comprises one or more audio files.

24. The system of claim 22 wherein content comprises one or more video files.

25. The system of claim 22 wherein content comprises one or more text files.

26. The system of claim 22 wherein content comprises one or more XML files.

27. The system of claim 22 wherein content comprises one or more images.

28. The system of claim 22 wherein content comprises one or more document files.

29. The system of claim 22 wherein content comprises links to content.

30. The system of claim 22 wherein metadata is operative to:
maintain associations between one or more items of content;
maintain hierarchies between one or more items of content; and
maintain dependencies between one or more items of content.

31. The system of claim 22 wherein the authoring environment is operative to extract metadata associated with the content received.

32. The system of claim 22 wherein the authoring environment is operative to receive user input identifying metadata for the one or more items of content received.

33. The system of claim 22 wherein the authoring environment is operative to identify the metadata according to one or more schemas.

34. The method of claim 33 wherein the one or more schemas comprise one or more common standard schemas.

35. The method of claim 33 wherein the one or more schemas comprise one or more user identified schemas.

36. The system of claim 22 wherein the authoring environment is operative to:
construct an index comprised of the metadata extracted from the one or more items of content; and
construct an index comprised of metadata received from user input for the one or more items of content.

37. The system of claim 22 wherein the authoring environment is operative to construct an index of word/location pairs corresponding to the one or more items of content received.

38. The system of claim 22 wherein the authoring environment is operative to store the content, metadata and index in an accessible data structure in accordance with a hierarchy.

39. The system of claim 38 wherein the hierarchy is identified by the metadata associated with the content.

40. The system of claim 38 wherein the hierarchy is identified by a user of the authoring environment.

41. The system of claim 38 wherein the hierarchy identifies an association between one or more existing accessible data structures.

42. The system of claim 22 wherein the authoring environment is operative to distribute the accessible data structure in response to a request.

43. The system of claim 22 wherein the authoring environment is operative to distribute the accessible data structure to predetermined locations.

44. The system of claim 22 wherein the viewer is operative to utilize one or more plug-in applications to display one or more items of content from the accessible data structure.

45. The system of claim 22 wherein the viewer is operative to retrieve and display one or more items of content according to the associations defined by the metadata.

46. The system of claim 22 wherein the viewer is operative to display the one or more items of content in accordance with the one or more schemas associated with the accessible data structure.

47. The system of claim 22 wherein the viewer is operative to:
receive user input modifying the one or more items of content; and
receive user input modifying the metadata associated with the one or more items of content.
